(19) United States
(12) Patent Application Publication
(10) Pub. No.: US 2006/0053288 A1
(43) Pub. Date: Mar. 9, 2006

(54) Interface method and device for the on-line exchange of content data in a secure manner

(75) Inventors: Julien Stern, Paris (FR); Thomas Pornin, Paris (FR)

Correspondence Address: YOUNG & THOMPSON, 745 SOUTH 23RD STREET, 2ND FLOOR, ARLINGTON, VA, 22202, US

(73) Assignee: CRYPTOLOG, Paris (FR)

(21) Appl. No.: 10/518,301

(22) PCT Filed: Jun. 17, 2003
(86) PCT No.: PCT/FR03/01841

§ 371 Date: Dec. 17, 2004

(30) Foreign Application Priority Data
Jun. 17, 2002 (FR) 02/07413

(51) Int. Cl. H04L 9/00

(52) U.S. Cl. 713/168

(57) ABSTRACT

The invention relates to a method for the on-line exchange of contents data, comprising the following method steps: reception of a code entered by a user on an interface device (4a-c), transmission of a first read request from said interface device to a first server device (3), in which are stored the respective personal cryptographic data for a number of users encoded by using a respective authentic code for said user, reception of the encoded personal cryptographic data for said user in said interface device, decoding said personal cryptographic data by means of said entered code when the entered code corresponds to the authentic code for the user, use of said personal cryptographic data to secure an exchange of contents data between said interface device and at least one second server device (2a-b) and erasure of said entered code and said personal cryptographic data from said interface device.

The present invention relates to an interface method and device for the on-line exchange of content data in a secure manner.

The expansion of data networks means that many services accessible on line, in other words remotely accessible via a data network, can be devised and used. Typical of such services are electronic commerce, the broadcasting of audio-visual programs, electronic mail, on-line banking and financial management services, access to data banks and roaming access to a virtual office, among other things. This type of service is normally made accessible by the service provider by means of one or more data servers linked to the data network. The use of such services involves exchanging content data, in other words data that conveys the content of the service, between a user interface device and at least one server of the service provider, via the data network.

However, this content data is normally of a personal nature or reserved for the user and/or for the service provider. To prevent any third party from capturing and using content data not intended for him, it is therefore essential to protect the exchanges of content data against a variety of risks. These risks may stem mainly from the existence of uncertainties regarding the identity of the sender or the recipient of the data exchanged and the possibility of data being diverted or altered while being transferred from the sender to the legitimate recipient. It is important here to understand that the terms “recipient” and “sender” are used to mean computers or similar devices linked to a data network, or users or operators of such computers devices.

Various cryptographic methods for providing such protection are known. For example, electronic signing methods enable any recipient of a message to check the identity of the sender and check that the content of the message has not been altered while being transferred. Authentication methods are used to check the identity of the correspondent involved in the data interchange. Encryption methods, symmetric and asymmetric alike, are used to convert the data to a format that cannot be used by any third party other than its legitimate recipient. These known cryptographic methods can be combined according to the requirements of each application.

Applying these cryptographic methods involves using an interface device capable of performing complex calculations, in other words a device similar to a computer in the broad sense of the term, such as a workstation, a cellular telephone, a personal digital assistant, a microcomputer, a television set-top box or a chip card. Such application is normally possible using a software implementation of the method on the interface device, a software implementation that may, if necessary, be public.

However, the software or hardware implementation of the cryptographic method, whichever it may be, can be used by a person to protect content data only when the implementation is configured using personal cryptographic data, in other words data specific to that person. There is personal cryptographic data which is for public use, such as a public key enabling any third party to check the electronic signature sent by that person, and personal cryptographic data which is for private use, such as a private key enabling the person to send his own signature. It is vitally important to keep this personal cryptographic data secret, at least that which is for private use. In practice, if a person other than the authentic owner of the personal cryptographic data takes possession of the latter, that person can use all on-line services in the name of the authentic owner and without being easily identified.

A number of solutions for keeping such personal cryptographic data are known.

A first solution involves using personal cryptographic data that is intrinsic to its owner and therefore does not require a hardware storage means. This type of personal cryptographic data encompasses passwords memorized by their owner and biometric data, such as fingerprints and retinal images.

The problem with biometric data is that it requires the use of a special reader which is expensive and not in common use. Furthermore, the biometric data has a fixed configuration which cannot be adapted to all the useful formats, for example, for use in the standard authentication and encryption methods such as OpenPGP (Open Pretty Good Privacy), S/MIME (Secure Multipurpose Internet Mail Extensions), and SSL (Secure Socket Layer).

The problem with passwords is that they demand a compromise, which is not always acceptable, between security and user-friendliness. In practice, shorter passwords are easier to memorize, but the encryption which is based on the password is easier to break by a systematic search, because of the smaller number of combinations to be tried. Conversely, longer passwords provide a correspondingly higher level of encryption security, but they are more difficult to memorize. Writing the password down on a crib sheet brings with it the risk of disclosure and forgetting the password on the part of the owner brings with it a risk of losing the data that it was used to encrypt.

A second known solution involves storing the personal cryptographic data locally on the device that applies the cryptographic method in which said data is managed. This solution typically involves storing the data on the hard disk of a microcomputer used as an interface device for using on-line services or in the read-only memory of a cellular telephone.

There are many problems with this solution: a person can exchange content data in a secure manner only by using the single device on which the personal cryptographic data is stored. This means it is possible to use on-line services only from a unique location, unless a portable device is used and carried to any location where the services are used. Furthermore, access to the device must be controlled, to prevent access from an unauthorized person to the personal cryptographic data. The device can even be placed in a strong room or a similar protected environment in certain cases, but this measure is not compatible with all on-line service usage contexts, for example with the context of roaming usage from a cellular telephone. Furthermore, if the device has to be used by several users, it must then store the personal cryptographic data of all the potential users, which increases the necessary storage volume. Finally, the personal cryptographic data may be irretrievably lost if the device is destroyed, lost or fails.

Duplicating personal cryptographic data on several devices does not solve all these problems. On the contrary, it makes controlled access to the multiple devices more difficult to apply.

In the case of desktop computers, a third solution combining the above-mentioned two solutions is also known. The personal cryptographic data is stored locally on the computer applying the cryptographic methods in which it is used, but it is stored in a form symmetrically encrypted using a key derived from a password. The PKCS#12 and OpenPGP standards describe this third solution.

One problem with this third known solution lies in the fact that a third party having taken possession of the device has everything he needs to try to obtain the personal cryptographic data by breaking its encryption by systematically testing passwords, which constitutes what is known as a “dictionary attack”.

A fourth known solution consists in storing the personal cryptographic data on a chip card. Document EP 1 150 506 A2 describes a system using this solution for a digital video data broadcasting application.

A chip card is easy to carry and can be shielded. However, the strength of the shielding depends on the cost and the format of the chip card. It is known that the shielding of standard chip cards can be successfully breached with a budget of around 10⁴ euros.

The problems with this fourth solution include the need to take the chip card to wherever the services are used, the need to have a compatible reader in the place of installation, the risks of losing personal cryptographic data should the chip card be destroyed, lost or fail, and the consequent risks of losing the encrypted content data.

U.S. Pat. No. 5,491,752 describes a method for recovering a private key on a remote server from a workstation acting in the name of a user, in which:
the user enters his password in the workstation;
the workstation converts the password into a symmetric encryption key by applying a hashing algorithm;
the workstation asks the remote server for the private key of the user, which is stored on the remote server in encrypted form using the symmetric key derived from the password;
the remote server sends this private key in encrypted form to the workstation, which decrypts it with the symmetric key.

The risks associated with such recovery are as follows:
if the password is recovered by a third party, the security of the system is directly compromised;
if the encrypted private keys are recovered by a third party, this third party can try what is called an off-line dictionary attack, in other words can try a large number of standard passwords (all the existing words in all languages, for example) without interacting with the server.

It is then possible to require the user to be authenticated so that the remote server transmits encrypted keys only to the user to whom they belong. For this, U.S. Pat. No. 5,491,752 proposes authenticating the user having the password before sending him his encrypted keys. The proposed techniques mainly involve sending the hashing value of the password to the server to prove to the server that the password is known. This value must be sent encrypted to ensure that it can be read only by the remote server.

This authentication of the user could be made more or less complex, but in all cases it requires the verification data to be stored initially on the remote server. In practice, it is impossible to identify a user from nothing. It should be noted that, whatever the method used, the remote server can make an off-line dictionary attack. The only data characterizing a user is his identifier (in principle, public) and his password. The remote server can therefore try a large number of passwords since it has direct access to the verification data.

It is therefore important to prevent the encrypted private keys, the verification data or any other information enabling an off-line dictionary attack from being obtained by a third party other than the server carrying out the checks.

To ensure the confidentiality of the hashing value of the password, this prior art presupposes that the public encryption key of the server is known. In other words, it is assumed that there is already a channel for ensuring that the data sent will be received by the remote server and only by that server.

This assumption is fairly sound. It would therefore be desirable to have a system for preventing the off-line dictionary attacks even in cases where there is no, in principle, authenticated and confidential channel to the server, particularly in a minimalist configuration where the only certain information known to both parties is the password of the user or a derivative of it.

It is in particular desirable that if the calls from the user are made with a fake server, the latter does not learn any information on the password.

An object of the invention is to rectify at least some of the above-mentioned problems by providing an interface method and device for exchanging content data on line which provides effective protection of the content data, which are easy to use and as widely accessible as possible.

For this, the invention provides a method for the on-line exchange of content data in a secure manner, comprising the steps consisting in:
receiving a code entered by a user in an interface device linked to a first server device by at least one data network,
sending a read request from said interface device to said first server device in which is stored the respective personal cryptographic data of a plurality of users, said personal cryptographic data of each user being encrypted using a respective authentic code of said user,
receiving the encrypted personal cryptographic data of said user in said interface device,
decrypting said personal cryptographic data using said entered code when said entered code corresponds to said authentic code of the user,
characterized in that it comprises the steps consisting in:
using said personal cryptographic data to protect an exchange of content data between said interface device and said at least one second server device linked to said interface device by at least one data network,
erasing said entered code and said personal cryptographic data from said interface device.

Within the meaning of the invention, a server device is a computer or similar device linked to a data network and programmed to make hardware and/or software resources available to a number of users, via usage interface devices, also called client devices, also linked to the data network.

Within the meaning of the invention, a data network can be any link means capable of transferring data, whether it be in optical, radiofrequency or electrical form, and can be made up of optical fibers, electrical cables, coaxial cables, radiofrequency or microwave or infrared transceiver stations, routers, repeaters, and any combination of these elements known to a person skilled in the art. A number of networks offering at least one point of passage from one to the others also constitutes a data network within the meaning of the invention.

The storage of the personal data for the users in the first server device, including personal cryptographic data, means that this data can be made remotely accessible from an interface device linked to the first server device. The personal cryptographic data of the user is in fact held available to the user without the latter having to carry a mobile device or a chip card.

The personal cryptographic data is stored on the first server device in encrypted form using an authentic code known only to the legitimate user, to ensure that the confidentiality is maintained, including with respect to the first server device.

The authentic code and the personal cryptographic data, encrypted or decrypted, is retained on the interface device only for the period of one session, in other words, the time needed to use the data, or respectively to decrypt the personal cryptographic data received from the first server and to protect by a cryptographic method an exchange of content data between the interface device and the second server device, after which it is erased from the interface device. Thus, the user does not need to control access to the interface device between two sessions, so the interface device can be used by many users, typically in a self-service context.

Preferably, said interface device and said first server device set up a confidential communication channel between themselves by sharing at least one encryption key offering a high degree of entropy in relation to said authentic code of the user, said encrypted personal cryptographic data being transmitted to said interface device via said confidential communication channel. The latter offers a first level of protection against dictionary attacks from a third party intercepting the communications between the interface device and the first server device. For this, a key exchange protocol can be used, enabling two parties having no prior common secret data to calculate such data then to use it, for example, as a symmetric encryption key, then called a session key.

Preferably, at least one personal code verification data item deriving from said authentic code of the user according to a deterministic function is stored in said first server device and said first server device explicitly or implicitly authenticates said interface device using said personal code verification data. The implicit authentication of the interface device means that the first server device, without having any guarantee as to the identity of its contact in this case, is assured that only an interface device having the authentic code will be able to interpret its response.

The deterministic function can be the identity function, in which case the first server device stores the authentic code itself. Advantageously, said deterministic function is a collision-resistant, irreversible function, in particular a cryptographic hashing function.

According to a particular embodiment of the invention, said interface device and said first server device simultaneously handle the sharing of said at least one encryption key and the explicit or implicit authentication of said interface device by said first server device using a Password-Based-Key-Exchange (PBKE) protocol.

Within the meaning of the invention, the term PBKE protocol is used to describe a family of protocols also known by the name Password Authenticated Key Agreement (PAKA). These protocols verify at least the following conditions:
the two parties use only a low entropy code in the sense of the number of possible implementations, for example a password or its derivative, as certain common data,
from said common data, the two parties set up a secure communication channel, in other words, based on at least one higher entropy key, without enabling off-line dictionary attacks from third parties seeking to procure this common data,
at least one of the two parties acquires a proof of authenticity of the other party, the authenticity being defined as the knowledge of the certain common data. This proof of authenticity may be explicit or implicit. An implicit authentication does not immediately provide a guarantee of authenticity of the other party; however, it guarantees that the high entropy key protecting the secure communication channel set up as part of the protocol can be known to the other party only if the latter knows the certain common data prior to execution of the protocol.

The standardization organization IEEE proposes a list of such protocols in document P1363.2, Standard Specifications for Password-Based Public-Key Cryptographic Techniques, Version 7, 20 Dec. 2002, which is incorporated by reference. The PBKE type protocols comprise a subfamily of protocols called Encrypted Key Exchange (EKE). EKE is a general concept, theoretically applicable to any key exchange protocol; however, for the time being, research in cryptography has finalized the technical details only in the case of Diffie-Hellman and its variants on other groups (such as, for example, on elliptical curves).

Such a protocol adds the protection of said at least one encryption key against interception by a third party who might intercept all communications between the interface device and the first server device without knowing said authentic code or its derivatives. This embodiment offers high security which does not rely on the prior existence of a secured channel to the remote server, or on the existence of information enabling one to be created immediately. The security of this embodiment with password-based key exchange does not in fact rely on any certain predefined data other than the password or authentic code of the user or its deterministic derivatives.

Preferably, said Password-Based-Key-Exchange type protocol includes a single communication in each direction between said interface device and said first server device. Advantageously in this case, said communication from the first server device to the interface device includes the transmission of the encrypted personal cryptographic data.

Advantageously, said interface device chooses a first integer corresponding to a first element of a predefined group and said first server device chooses a second integer corresponding to a second element of said group, for example in the form g^{x} mod p, then said interface device and said first server device send each other said first and second elements, said interface device and said first server device each producing said at least one encryption key by combining the integer chosen by itself and the element received by itself, said first element of the group being transmitted to said first server device in an encrypted form using a distinguishing trace which derives from said code entered by the user in the interface device according to said deterministic function, said first element of the group being decrypted by said first server device using said personal code verification data, said second element of the group being transmitted to said interface device in a symmetrically encrypted form using said personal code verification data, said second element of the group being decrypted by said interface device using said distinguishing trace. Thus, a PBKE protocol on the Diffie-Hellman protocol can be used to recover the encrypted personal cryptographic data on the remote server with authentication by password and resistance to off-line dictionary attacks.

Preferably, said first and second elements of the group are encrypted with a symmetric encryption protocol which is chosen such that an attempt to decrypt one of said elements of the group according to said protocol always produces an element of said group, whatever the key used in said attempt.

Preferably, said first and second elements of the group are encrypted with a symmetric encryption protocol which is chosen such that said integer cannot be obtained from the element of the corresponding encrypted group. Thus, off-line dictionary attacks from a fake server or an attacker intercepting all communications are rendered virtually impossible.

According to a particular embodiment, said first element of the group, respectively said second element of the group, is encrypted with a symmetric encryption protocol which comprises the step consisting in composing said element by a composition law of said group with the image of said distinguishing trace, respectively the image of said personal code verification data, by a function with values in said group.

Preferably, said usage step comprises the step consisting in authenticating said user with said at least one second server device using the authentication data of said user included in said personal cryptographic data. For example, the authentication data comprise a digital certificate of the user.

According to a particular embodiment of the invention, said usage step comprises the steps consisting in:
receiving content data entered by said user in said interface device,
encrypting said content data using at least one encryption key included in said personal cryptographic data,
sending said encrypted content data to said at least one second server device to store said encrypted content data in said second server device and/or transmit it to a recipient.

This embodiment can be applied to write-mode access to a personal data bank and the sending of encrypted electronic mail. For example, the encryption key is a strong cryptographic key, typically greater than or equal to 128 bits, for symmetrically encrypting said content data.

According to another particular embodiment of the invention, said usage step comprises the steps consisting in:
sending a second read request specifying content data from said interface device to said at least one second server device,
receiving said encrypted content data from said at least one second server device in said interface device,
decrypting said content data using at least one decryption key included in said personal cryptographic data.

This embodiment can be applied to the reception of encrypted electronic mail, the reception of audio and/or video content data, and read-mode access to a personal data bank, said content data being personal data which has been previously encrypted using said personal cryptographic data and stored by said user in said second server device. This embodiment can also be used, in the case where the second server is also a key server similar to the first, to access private keys of the user stored in encrypted form on the second server. the connection to the second server is then set up using the personal cryptographic data recovered from the first server. Thus, the protection of the private keys is enhanced by making their recovery dependent on the success of a series of prior connections to several successive key servers.

According to another embodiment, said first read request includes a distinguishing trace of said entered code and said personal data of each user comprise personal code verification data for checking that said entered code corresponds to said authentic code of the user, said encrypted personal cryptographic data of said user being received in said interface device only if said entered code corresponds to said authentic code of the user. A distinguishing trace of the code is a trace which can be used to differentiate two different codes. It may be the code itself—but this embodiment is not recommended for reasons of security—or an image of the code by a deterministic and collision-resistant cryptographic function, in other words, a function which presents a property of injectivity in the calculative sense of the term, in that it is technically impossible to construct two antecedents of the same image.

The distinguishing trace is used to prove that the user knows the authentic code, as far as possible without divulging the authentic code.

Thus, the code entered by the user of the interface device is used to authenticate the latter to the first server and the personal cryptographic data is sent to the user only when he has proved that he knows the authentic code, which prevents a third party from receiving the encrypted personal cryptographic data to try to break its encryption by systematic tests. For example, the personal code verification data can include an identifier of the user and the authentic password or a data item derived from the latter.

Advantageously, the method according to the invention comprises the steps consisting in:
calculating said distinguishing trace as an irreversible transform of the code entered in said interface device,
said personal code verification data stored in the first server device comprising a similar transform of said authentic code. The personal code verification data stored in the first server device devolves from an irreversible transform of the authentic code, so that the authentic code of the user cannot be retrieved from personal code verification data stored in the first server device. This means that even the first server device and its operators cannot easily retrieve the authentic code.

To prove that the user knows the authentic code, it is also possible to consider the use of a zero disclosure cryptographic proof protocol, in other words, a proof protocol for which it is possible to prove mathematically that it adds no information to the data the knowledge of which it proves. This zero disclosure proof does, however, present two problems: the first is that it does not on its own prevent active attacks in which an adversary intercepts and modifies all communications between the user and the server. The second is that it requires two phases: a first, authentication phase and a second phase for sending encrypted keys, and therefore a number of network round trips.

Preferably, the method according to the invention comprises the step consisting in imposing a predefined minimum delay between the processing of two successive occurrences of said first read request on the first server device, on pain of not recognizing the longest delayed occurrence. In this way, an attempt to obtain personal data by an on-line dictionary attack, consisting in sending a multitude of successive occurrences of the first read request, systematically varying the code included in it, is made virtually impossible.

In practice, a password offers only low security: it is sensitive to dictionary attacks. A dictionary attack involves assuming that the password is taken from a list of possible passwords, and trying each word in the list. A typical password (in other words, a password that a user can memorize) may typically be found in a few hundred thousand tests. There are two different types of dictionary attacks:
on-line attacks: each test requires an interaction with an entity legitimately knowing the password (for example a networked information technology server);
off-line attacks: the attacker has all the data required to “try” each password on his own computers and check its validity.

Off-line attacks are fatal, because only the power of the computer of the attacker limits the number of tests that it will be able to carry out in each second; a realistic rate is around 10 000 tests per second, which means that the password will be found in a few minutes. On-line attacks, however, can easily be countered: all that is needed is for the contacted server to limit the number of tests on the part of the attacker, typically by imposing a delay on each response, or by refusing to respond after a certain number of unsuccessful tests.

Preferably, the method according to the invention comprises a step consisting in systematically monitoring communications involving said first server device. In practice, the read requests received by the first server device and the cryptographic data sent in response by the first server device are few in number and low in volume, which makes such a control possible without being excessively expensive. Advantageously, the first server device is exclusively dedicated to storing the personal data of the users and making the data available to its owners as and when the latter require, at the start of a session, which helps to limit the volume of said communications.

Advantageously, the method according to the invention comprises the step consisting in:
checking the integrity of the personal cryptographic data received from said first server device using integrity control data attached to said personal cryptographic data received from said first server device. Thus, any alteration of the personal cryptographic data can be detected as it is being transmitted from the first server device.

Preferably, the method according to the invention comprises the step consisting in authenticating said first server device to said interface device before sending said first read request. In this way, a fake first server device is prevented from receiving the request, which can contain the distinguishing trace of the authentic code of the user, and therefore from being able to mount a dictionary attack on the authentic code.

Advantageously, the method according to the invention comprises the step consisting in setting up a confidential communication with the first server device before sending said first read request from the interface device. Thus, any third party intercepting communications between the first server device and the interface device is prevented from reading the first request, which can contain the distinguishing trace of the authentic code of the user, and therefore from being able to mount a dictionary attack on the authentic code. For example, the authentication of the first server device and/or the setting-up of a confidential communication are achieved using a digital certificate of the first server device and the SSL protocol.

Preferably, the method according to the invention comprises a registration step consisting in:
providing the personal cryptographic data in said interface device,
receiving an authentic code entered by said user in said interface device,
encrypting said personal cryptographic data using said authentic code,
sending said encrypted personal cryptographic data from said interface device to said first server device to store said encrypted personal cryptographic data in said first server device,
erasing said personal cryptographic data and said authentic code from said interface device.

Advantageously, the registration step also comprises the steps consisting in:
forming personal code verification data from said authentic code,
sending said personal code verification data from said interface device to said first server device to store said personal code verification data in said first server device.

The personal cryptographic data can be made available by reading said data on a medium such as a chip card or by generating said data in the interface device from a random number generator.

For example, the authentic code is a password memorized by the user, which is transformed into a cryptographic key in the interface device to systematically encrypt at least some of the personal cryptographic data.

Preferably, the method according to the invention comprises a step consisting in rejecting said authentic code entered by the user when said code satisfies predefined evidence criteria. Thus, from the registration step, there is an assurance that the authentic code cannot be an obvious code, which reinforces the security of the data stored on the first server device against dictionary attacks instigated to fraudulently obtain the authentic code and the personal cryptographic data, including by persons having control of the first server device. For example, the predefined evidence criteria may impose a minimum number of characters and a minimum number of non-alphanumeric characters, and exclude common character strings such as dates, first names, etc.

Preferably, the method according to the invention comprises the step consisting in authenticating said first server device to said interface device before sending said encrypted personal cryptographic data. Advantageously, the method according to the invention comprises the step consisting in setting up a confidential communication between the interface device and the first server device before sending said encrypted personal cryptographic data. In this way, any third party passing itself off as the first server device or snooping on exchanges between the first server device and the interface device is prevented from receiving the encrypted personal cryptographic data and therefore from being able to mount a dictionary attack on the authentic code to decrypt said personal cryptographic data.

The invention also provides an interface device for the on-line exchange of content data in a secure manner, comprising a means for receiving a code entered by a user,
a means for sending a first read request from said interface device to a first server device in which respective personal cryptographic data of a plurality of users is stored, said personal cryptographic data of each user being encrypted using a respective authentic code of said user,
a means for receiving the encrypted personal cryptographic data of said user from said first server device,
a means for decrypting said personal cryptographic data using said entered code when said entered code corresponds to said authentic code of the user, characterized by the fact that it comprises:
means for using said personal cryptographic data to protect an exchange of content data between said interface device and at least one second server device, a means for erasing said code and said personal cryptographic data from said interface device.

The interface device according to the invention can be produced as a device, the hardware design of which is dedicated to this purpose, or as a device of conventional hardware design, for example a generic microcomputer, programmed using a computer program dedicated to this purpose, or as a combination of the two. The interface device according to the invention can also be produced as a computer program. Within the meaning of the invention, a computer program comprises instruction codes designed to be read or stored on a medium and executable by a computer or a similar device.

According to a particular embodiment of the invention, the device consists of an electronic mail management program, said means of using the personal cryptographic data comprising a cryptographic module for signing, encrypting and/or decrypting electronic mail using at least some of said personal cryptographic data.

According to another particular embodiment of the invention, the device consists of a plug-in module suited to an electronic mail management program comprising a cryptographic module for signing, encrypting and decrypting electronic mail, said means of using the personal cryptographic data comprising a means for providing said cryptographic module with at least some of said personal cryptographic data.

Separately from the above device, or incorporated in the latter, the invention also provides a registration interface device, characterized in that it comprises:
a means for providing personal cryptographic data in said interface device,
a means for receiving an authentic code entered by said user in said interface device,
a means for encrypting said personal cryptographic data using said authentic code,
a means for sending said encrypted personal cryptographic data from said interface device to a first server device to store said encrypted personal cryptographic data in said first server device, in which the respective personal cryptographic data of a plurality of users is stored, said personal cryptographic data of each user being encrypted using a respective authentic code of said user,
a means for erasing said personal cryptographic data and said authentic code from said interface device.

The invention will be better understood, and other purposes, details, features and advantages will become more clearly apparent, from the following description of a number of particular embodiments of the invention, provided purely by way of non-limiting illustration, with reference to the appended drawings, in which:

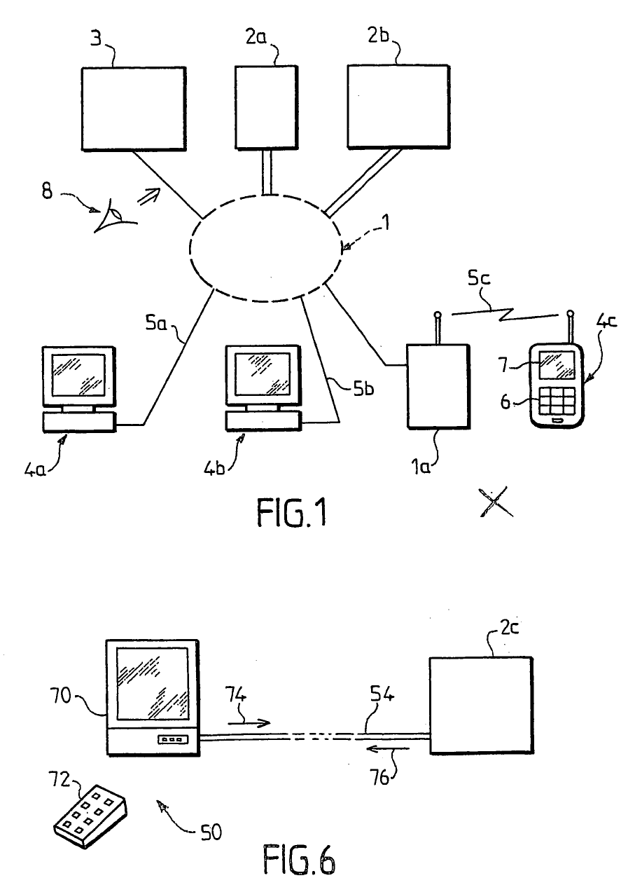

FIG. 1 is a schematic diagram of a system for applying the method of exchanging data according to the invention,

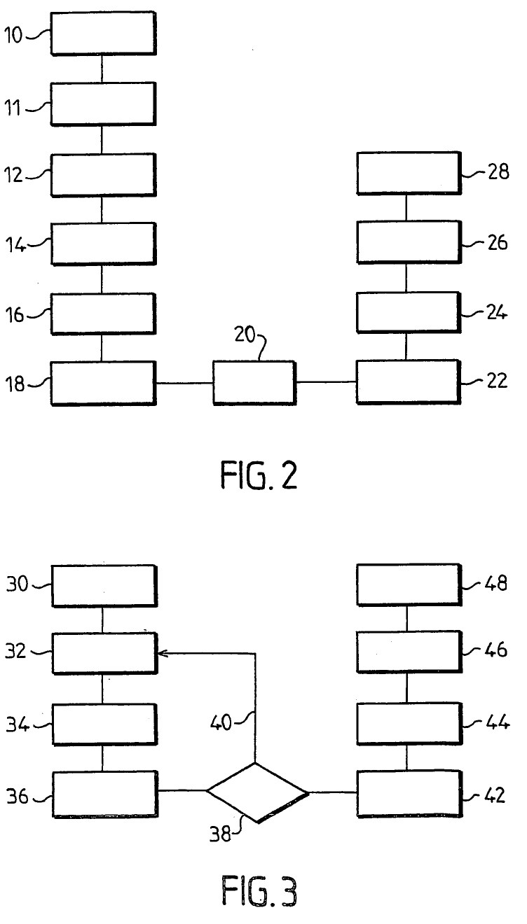

FIG. 2 is a diagram representing a registration step of the method of exchanging data according to the invention,

FIG. 3 is a diagram representing a usage session of the method of exchanging data according to the invention,

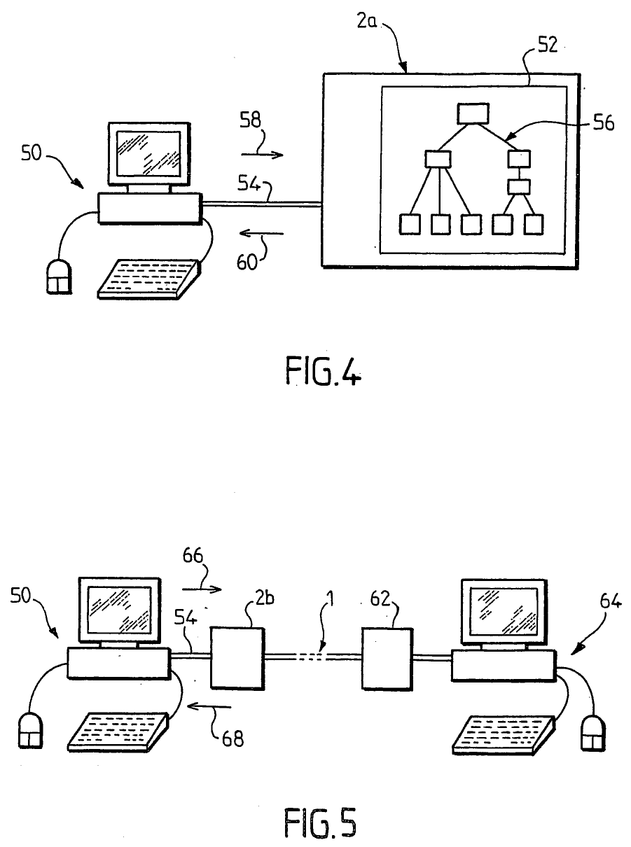

FIG. 4 represents an application of the method according to the invention to a personal data bank,

FIG. 5 represents an application of the method according to the invention to secured electronic mail management,

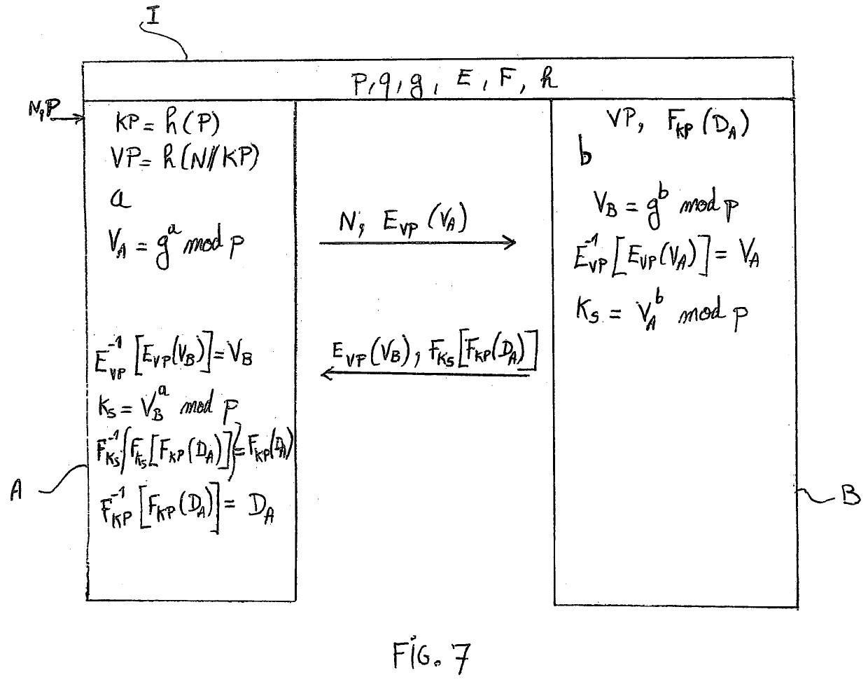

FIG. 6 represents an application of the method according to the invention to audio-visual broadcasting,

FIG. 7 represents another embodiment of the usage session.

Referring to FIG. 1, a data network 1, for example the Internet, interlinks the content servers 2a and 2b offering on-line services, a key server 3 and the interface devices 4a, 4b, 4c to use the services offered by the content servers 2a and 2b. The interface devices 4a, 4b are conventional computers comprising a memory, a data processing unit and input/output and storage devices. They are linked to the network 1 by wired links 5a and 5b. The interface device 4c is a cellular telephone also comprising a memory, a data processing unit, a keyboard 6 and a screen 7. It is linked to the network 1 via a radio link 5c with a transceiver station 1a incorporated in the network 1. Although only two content servers and three interface devices are shown, the system can include a very high number of content servers and/or interface devices. The invention is not limited in this respect. Furthermore, one and the same computer can simultaneously comprise a number of servers, the latter being implemented in a software form, each having a specific address on the network 1. To this end, the key server 3 can be implemented by the same computer as a content server.

The content servers 2a and 2b are used to supply the users of the interface devices 4a, 4b, 4c with services involving content data. For example, the content servers 2a and 2b may comprise website servers, electronic mail servers, audio/video data servers, fax servers, file transfer protocol FTP servers, broadcast list servers, real time chat IRC servers, information servers, electronic commerce servers, etc.

The key server 3 is a server exclusively dedicated to storing personal cryptographic data and personal code verification data of a plurality of users registered with the key server 3 or its operator, and to transmitting to any interface device from which a registered user requests it the personal cryptographic data of that user.

To reinforce the security of the personal data stored on the key server 3, the latter is preferably located in a location protected by shielding and/or access restrictions. Furthermore, the key server 3 is as far as possible physically closed, in particular by closure of the non-essential communication ports. Because of the restricted functions provided by the key server 3, the number of ports to the latter and the volume of data that it exchanges are fairly limited. Conversely, the content data is normally voluminous and can be the subject of many simultaneous accesses, so that the volume of the exchanges between each content server 2a or 2b and the network 1 is normally far greater than between the key server 3 and the network 1, which is symbolized by the thickness of the link lines between the respective servers and the network 1.

The small size of the data streams to and from the key server 3 means that a monitoring system 8, symbolically represented in FIG. 1, monitors in real time communications between the key server 3 and the network 1, for example by monitoring the log file of the key server 3.

To register with the key server 3, a user performs, from an interface device 4a-c, a registration step which will now be described with reference to FIG. 2.

In the step 10, the user runs a registration application on an interface device, for example a microcomputer linked to the network 1.

In the step 11, the interface device generates personal cryptographic data for the user. To be able to perform a symmetric encryption/decryption of content data, a private key KS is generated using a reliable pseudo-random generator embedded in the interface device and using a random initialization data item originating from a physical measurement. There are a number of methods for obtaining such an initialization data item, for example, by asking the user to press keys randomly on the keyboard of the interface device and by accurately timing the time intervals between successive key strokes. To be able to apply a public key encryption method, a pair of keys formed by a public key KB and a corresponding private key KR is generated. All these keys are chosen to be long enough, for example 128 bits or more, to ensure a high level of cryptographic security.

In the step 12, the user has his public key KB certified by a certification authority, which can be an independent entity (not shown) or the key server 3, according to a known technique. Such a certification is used to prove that a public key KB belongs to this specified person, who is the only one to own the corresponding private key KR. The user thus obtains a digital certificate A which contains the public key KB and different data identifying its owner, such as the name of the user, his address, his age, etc. For example, the digital certificate A is in the X.509 standardized format, which can be used in the SSL encryption protocol. The private key KR, the digital certificate A and the symmetric key KS form the personal cryptographic data of the user.

The steps 11 and 12 are simply an example of the provision of the personal cryptographic data of the user in the memory of the interface device. As a variant, the user could have obtained such keys previously, for example from a medium such as a chip card, and loaded this data into the memory of the interface device using an appropriate reader. Since this provisioning step needs to be carried out only once, the chip card could then be locked away in a safe to be used as a backup copy.

The personal cryptographic data within the meaning of the invention is not limited to a combination of the above-mentioned keys. This data could also be limited to a single private key or, conversely, be more numerous. However, it is preferable to provide separate keys for each function. In the present case, the pair formed by the certificate A and the private key KR is used by the user authentication function and the private key KS by the content data encryption/decryption function.

In the step 14, the user is prompted to enter a personal identifier N, such as his name or pseudonym, and a personal password in the interface device. This password is chosen by the user. If the password entered has fewer than eight characters or fewer than two non-alphanumeric characters, it is rejected automatically and the prompt is repeated. When an acceptable password is entered, the user is prompted to confirm it by entering it a second time, in order to ensure that the user has not made any errors in his choice and knows his password with certainty. The password, once confirmed, is stored as the authentic password P of the user.

In the step 16, the authentic password P is converted irreversibly into a symmetric encryption key KP by applying a hash function to the concatenation of the identifier N and the authentic password P of the user. for example, the hash function used is the SHA function defined by the standard FIPS 180.

In the step 18, a personal password verification key VP is calculated by an irreversible injective transformation of the authentic password P. For example, VP results from the application of a hash function to the symmetric encryption key KP.

In the step 20, the private key KR and the digital certificate A are symmetrically encrypted using the symmetric key KS. The symmetric key KS is symmetrically encrypted using the encryption key KP resulting from the authentic password P. As a variant, all the personal cryptographic data could be encrypted using the encryption key KP. In all cases, the personal cryptographic data of the user is assumed to have been encrypted by the authentic password P, in other words, that it is encrypted in such a way that the authentic password P is needed to decrypt it.

In the step 22, the interface device sets up a secured communication with the key server 3 via the network 1. For this, the SSL standard protocol can be used, which ensures the confidentiality and integrity of the data exchanged between the interface device and the key server 3, as well as the authentication of the key server 3 with the interface device. The SSL protocol has a number of variants, one of which is described below.

The interface device contacts the key server 3 and indicates to it its intention to communicate with it. The key server 3 randomly chooses a pair of keys formed from a public key PA and a private key KV, corresponding to the Diffie-Hellman standard algorithm. The key server 3 has a public certificate CA which contains another public key SP of the key server 3, which has a corresponding respective private key SR of the key server 3. The key server 3 transmits to the interface device the public certificate CA, the public key PA and an electronic signature of the public key PA by the private key SR. The interface device checks the signature of the certificate CA using the public key of the certification authority that signed it, and checks the signature of the public key PA using the public key SP. The interface device randomly chooses a pair of keys formed from a public key PB and a private key KW, according to the Diffie-Hellman algorithm, and transmits the public key PB to the key server 3. The key server 3 calculates a session key KT according to the public key PB and its private key KV. The interface device calculates a session key KT according to the public key PA and its private key KW. The Diffie-Hellman algorithm ensures that the interface device and the key server 3 calculate the same session key KT, in other words, that they obtain the same calculation result in different ways. This result cannot be calculated without knowing at least one of the private keys KV and KW.

More specifically, according to the Diffie-Hellman protocol, two parties, denoted A and B, want to establish a common session key between them. Some parameters are known publicly and are not specific to a A or to B:
p, a large prime number (for example 1024 bits);
q, an integer number dividing p−1, of average size (for example 160 bits);
g, a modulo p integer generating an order q subgroup of Z*ₚ.

The procedure here is to work modulo the integer p, on the group Z*ₚ of modulo p reversible numbers. The subgroup generated by g is made up of all the powers of g modulo p; this subgroup comprises q different values. The Diffie-Hellman protocol is as follows:
A randomly chooses an integer a modulo q; this choice is made uniformly between 0 and q−1 (inclusive).
A calculates g^{a} mod p and sends the result to B.
B randomly chooses an integer b modulo q; this choice is made uniformly between 0 and q−1 (inclusive).
B calculates g^{b} mod p and sends the result to A.
A uses a and g^{b} mod p to calculate the value K_{A}=(g^{b})^{a} mod p.
B uses b and g^{a} mod p to calculate the value K_{B}=(g^{a})^{b} mod p.

By the commutative property of the modulo p multiplication, it turns out that K_{A}=K_{B}=g^{ab} mod p.

This common value is the session key.

The security of the Diffie-Hellman protocol is based on the difficulty in finding the integer a, because a is chosen randomly, from g^{a} mod p. This problem is known by the name of discrete logarithm. If p is large enough (for example 1024 bits) and a is chosen from a sufficiently vast set (in other words, q is large enough—at least 160 bits), then the discrete logarithm is beyond the capability of existing technology.

The original description of the Diffie-Hellman protocol uses the modulo p integers, but can be extended to any group on which the equivalent of the discrete logarithm is a “difficult” problem, in other words, one that cannot be solved by current computing means. An example of such a group is an elliptic curve: an elliptic curve is a set of points, each point having two coordinates in a finite body. On this curve it is possible to define a rule for adding two points, which provides a third point of the curve and satisfies the conditions necessary to be a group law.

The Diffie-Hellman protocol presupposes that the exchanges are honest, in other words, that the data sent by A and by B is not modified on the way by an attacker. The Diffie-Hellman protocol does not authenticate the two parties. This is why it is necessary to have the public certificate CA of the key server in the above-mentioned SSL protocol.

At this stage, the two parties have shared a temporary key KT which only they know. Moreover, the key server 3 is authenticated with the interface device through the proof of identity formed by the certificate CA. All their subsequent exchanges are made, for the sender, by symmetrically encrypting the data to be sent with the session key KT and, for the receiver, by decrypting the received data with the session key KT. The content of the data exchanged in this way is totally secret with respect to any intermediate transfer device.

In the protocol described above, the client, in other words, the interface device or its user, is not yet authenticated with the key server 3. It may be desirable to authenticate the client with the key server 3 in the registration procedure, in particular to avoid allowing a third party to overwrite or modify the account of a previously registered user. This authentication can be performed by any known method enabling the client to be identified to the registration authority controlling the key server 3.

For example, the registration authority may require a physical meeting with a future user prior to his registration to familiarize itself with his identity through the presentation of official documents at a registration desk. At this time, the registration authority can assign a password, and communicate it confidentially to the future user, that must be entered by the user on the interface device to set up the above-mentioned SSL connection.

As a variant, or in combination with the use of a password assigned by the registration authority, the SSL protocol can also be used in a bi-authenticated manner: for this, the interface device uses its digital certificate A containing the public key KB. The interface device signs the public key PB using the private key KR and sends the signed public key PB and the certificate A to the key server 3. The key server 3 checks the signature of the certificate A using the public key of the certification authority that signed it, and checks the signature of the public key PB using the public key KB. Thus, the user of the interface device is authenticated with the key server 3 through the proof of identity formed by the certificate A.

Preferably, all the data packets M exchanged between the interface device and the key server 3 include integrity checking means enabling the recipient to check that the data has not been altered between its transmission and its reception. An example of such checking means, which is applied in particular when the encryption of the data exchanged is performed using a block-based symmetric encryption function, consists in concatenating with the data packet M proper, prior to its encryption with the session key KT, the result of the application of a hash function to the data packet, or SHA(M) for example. After decryption, the recipient of the data packet can thus check that the data it has received does indeed have an M//SHA(M) type structure, which enables the recipient to detect any alteration of the data during the communication and to report this to the sender so that the sender can repeat the transmission or apply another security measure.

In these conditions, in the step 24, the interface device sends to the key server 3, in a secured manner, a request to create a personal user account containing: the identifier N, the personal cryptographic data A, KR, KS encrypted by the authentic password P and the password verification key VP. The key server 3 stores this data in an account, in other words, a storage space, reserved for the user, typically on a hard disk.

In the step 26, the key server 3 sends an account creation confirmation message. The exchanges between the interface device and the key server 3 are now finished with respect to the registration and the temporary session key KT can be erased by both parties.

In the step 28, the user closes the registration application, which causes the authentic password P and all the personal cryptographic data A, KB, KR, KS, whether encrypted or not, to be erased from the memory of the interface device. No confidential data of the user remains in the memory of the interface device, so the user is not linked to this particular device and no control on access to the latter is necessary subsequently. The interface device can be accessible to the public, typically in a cyber cafe.

The registration step thus enables the user to store on the key server 3, which is accessible from any interface device linked to the network 1, personal cryptographic data in encrypted form which only he can decrypt. The encryption obtained using the key KS is a strong encryption which is thought to be unbreakable because of the length of this key. The encryption obtained using the key KP is generally less strong because it derives directly from the password P which must be of a reasonable length to be remembered by the user. However, the password P is not stored on any medium. It cannot be found directly from the verification key VP, other than by a systematic search. Furthermore, such a systematic search could be performed only by the key server 3, which is the only one to store the verification key VP. The latter is never communicated in clear over the network 1.

Starting from the step 10 above, an on-line registration procedure for authenticating the key server 3 and, where appropriate, authenticating the user, has been described, as has the confidentiality of the exchanges between the user and the key server 3. Other registration procedures providing the same guarantees are nevertheless possible. For example, the user may be shown by the registration authority into a shielded room containing the key server 3, in which case the authentication of the server and the confidentiality of the communications are assured by non-cryptographic means, simply by the fact of the absence of any intermediate communication device and of the physical isolation of the parties from the outside world.

Subsequently, the user can use his personal cryptographic data from any interface device linked to the network 1 and equipped with an appropriate session application. With reference to FIG. 3, there now follows a description of a usage session from an interface device.

In the step 30, the user starts up the session application.

In the step 32, the user is prompted to enter his identifier N and his authentic password P. The user types in an identifier N′ and a password P′.

In the step 34, a symmetric encryption key KP′ is calculated from the password P′ and the identifier N′ in the same way as the symmetric encryption key KP in the step 16. Then, a key VP′ is calculated from the symmetric encryption key KP′ in the same way as the verification key VP in the step 18.

In the step 36, the interface device sets up a secured communication with the key server 3 via the network 1, for example using the SSL standard protocol as in the step 22. However, at this point, the interface device does not have the certificate A of the user. It generates a pair of public/private keys specially to set up this communication, which means that the key server 3 cannot authenticate the user at this stage. The interface device uses this secured communication to send the key server 3 a read request containing the identifier N′ and the key VP′.

In the step 38, the key server 3 processes this request by identifying the account corresponding to the identifier N′, if one actually exists, and by comparing the verification key VP stored in this account with the key VP′ received in the request.

If the account does not exist, or if the comparison is negative, this indicates that the user has not entered the identifier/authentic password pair of a registered user. In practice, because of the collision resistance of the hash function, as long as P′ is different from P, VP′ will be different from VP. The key server 3 then returns a message denying access, as indicated by the arrow 40. Thus, the method ensures that the encrypted personal cryptographic data will be sent only to a user who has proved that he knows the identifier/authentic password pair.

The steps 32 to 38 are then repeated, until the key server 3 receives a second occurrence of the read request. However, for one and the same identifier N′, the key server 3 performs the comparison provided for in step 38 only after a delay greater than 10 seconds from receipt of the first occurrence of the read request. Because of this, for an 8-character password, automatically trying all the possible passwords by the automated transmission of successive requests would take an unreasonable length of time, a million years or so.

When the step 38 has resulted in the recognition in the N′/VP′ pair of the authentic code N/VP of a registered user, in the step 42 the key server 3 sends to the interface device the encrypted personal cryptographic data A, KR, KS stored in the corresponding account. The interface device sends to the key server 3 an acknowledgement of receipt, and then the communication between them is terminated.

In the step 44, the interface device decrypts the key KS using the key KP′ calculated in the step 34, then decrypts the certificate A and the corresponding private key KR using the duly obtained key KS.

In the step 46, the user accesses services offered by one or more content servers 2a, 2b from the interface device. In this step, communications between the or each content server 2a, 2b and the interface device are protected by encryption, electronic signature and/or authentication procedures using the personal cryptographic data A, KR, KS. A number of detailed examples of this step are described below.

In the step 48, since the use of the services is finished, the user closes the session application, which causes the password P′, the keys KP′ and VP′ and all the personal cryptographic data A, KR, KS, whether encrypted or not, to be erased from the memory of the interface device. No confidential data of the user remains in the memory of the interface device, so the user is not linked to this particular device and no control on access to the latter is necessary subsequently. The interface device for the session step can also be accessible to the public, for example in a cyber cafe.

The storage of the personal cryptographic data on the key server 3 is safer, from the point of view of confidentiality and durability, than local storage on the interface device or storage on a chip card, because the key server 3 is better protected physically and can be carefully monitored.

There now follows a description of another embodiment of the session application, with reference to FIG. 7. By convention, the interface device is designated A and the key server 3 is designated B. A and B share a public data infrastructure I comprising numbers p, q and g suited to the Diffie-Hellman protocol, at least one hash function h, for example SHA-1, and encryption protocols E and F.

In A, the user (assumed to be authentic in the example shown) initially enters only his identity N and a password P. B has on his internal storage system the personal cryptographic data D_{A} of the user symmetrically encrypted with the key KP deduced from the password P; F denotes the encryption function used, which means that B stores F_{KP}(D_{A}). A will recover this data DA. It is assumed that B stores VP=h(N∥KP) (but not KP): the issue is to hash the concatenation of the name N and the key KP derived from the password P.

The protocol is as follows:
A calculates KP and VP using the data N and P entered by the user.
A chooses an integer a between 0 and q−1.
A calculates V_{A}=g^{a} mod p.
A sends B its name (N) and E_{h(N∥KP)}(V_{A}).
B chooses an integer b between 0 and q−1.
B calculates V_{B}=g^{b} mod p.
B decrypts E_{h(N∥KP)}(V_{A}) and obtains V_{A}.
B calculates K_{S}=V_{A}^{b} mod p.
B sends A the following two messages:
   E_{h(N∥KP)} (V_{B})
   F_{Ks}(F_{KP}(D_{A})
A decrypts E_{h(N∥KP)}(V_{B}) and obtains V_{B}.
A calculates K_{S}=V_{B}^{a} mod p.
A decrypts F_{Ks}(F_{KP}(D_{A})) and obtains F_{KP} (D_{A}).
A decrypts F_{KP}(D_{A}) and obtains D_{A}.

The encryption system F is a simple symmetric encryption system, typically using the AES standard algorithm. It can also have an integrity checking system (MAC), which is used to verify that the decryption is correct and that the data have not been altered.

The symmetric encryption system E used should be such that:

1. If VP′ is different from VP, the decryption by VP′ of E_{VP}(V_{A}) should give another valid element of the group generated by g; in other words, the use of a password other than the correct one should give a valid instance of the problem (but, of course, this does not culminate in the correct session key).

Now let us assume that A is honest but is led to negotiate with an attacker C having taken the place of B. The first condition on E protects A. In practice, when C receives F_{VP}(V_{A}), it can “try” different passwords P′ and see which give “valid” decryptions, in other words, elements of the group generated by g. If the condition 1 is not observed by E, then this gives C a means of “testing” off-line the passwords in its dictionary. After a few exchanges of this type, C would obtain enough test criteria to find the password P in its dictionary.

2. Given E_{VP}(g^{a} mod p), the only way of knowing the integer a should be to have chosen it previously.

The second condition prevents an attacker from subsequently using a failed session as a test for a dictionary attack. One possibility for the attacker C (passing itself off as B) is to arbitrarily choose a password P″ in the key negotiation and to send E_{VP″}(g^{b} mod p). Then, A uses the session key Ks (that C does not know, unless it has by chance chosen the right password) to encrypt a message addressed to C. The purpose of C is to use this message to try passwords; for each, denoted P′, C wants to reconstitute the b′ such that E_{VP′}(g^{b′} mod p) is equal to the value that it actually sent to A. If C can do this, then C can, for each password P′, calculate the corresponding session key K′, and check whether it correctly decrypts the message then sent by A. If it does, then C has, after the fact, found the password P used by A on executing the protocol. This constitutes an off-line dictionary attack. The condition 2 on the encryption E prevents precisely this attack being possible.

An example of encryption E which observes these conditions is as follows: a hash function H is available, the output of which is an element of the group generated by g, and Eₙ(V_{A}) is defined as the modulo p multiplication of V_{A} by H(n).

This embodiment is based on a general technique called encrypted key exchange (EKE), described for the first time in a paper entitled “Encrypted Key Exchange: Password-Based Protocols Secure Against Dictionary Attacks”, Steven M. Bellovin and Michael Merritt, in Proceedings of the IEEE Symposium on Security and Privacy, Oakland, Calif., May, 1992, pp. 72-84.

It avoids any off-line dictionary attack, even in the case of an adversary capable of intercepting and modifying the communications, and, moreover, it requires only one network round trip.

The client and the server use VP=h(N∥KP) as unique certain predefined data known to the client and the server. The negotiated session key K is then used to transmit confidentially the data packet containing DA from the server to the client.

This protocol has the following features:
There is only one pass: a request from the client, a response from the server, and the connection is stopped.
A fake client A talking to a legitimate server B, or a fake server B negotiating with a legitimate client A, or an attacker snooping or trying to modify a conversation between a legitimate client A and a legitimate server B, will not learn anything that can be used to mount an off-line dictionary attack, however partial, on the password P.
The server B does not know the password P (but it knows enough to make an off-line dictionary attack: h(N∥KP) and F_{KP} (D_{A})).
At the end of the protocol, if all the decryptions have been carried out correctly, A has authenticated B, in other words, it has the assurance of having spoken to a server knowing h(N∥KP).
At the end of the protocol, B has no explicit guarantee of having spoken with the true client A; however, B knows that only the true client A can obtain anything from the data that it has sent, which represents an implicit authentication of A. Thus, the protocol offers a guarantee of anonymity to the client and therefore a desirable protection when the connections from the user to the key server 3 are based on his private life.

The use h(N∥KP) instead of h(KP) is intended to prevent B (in the case where his storage system is compromised by an attacker) from mounting an off-line dictionary attack in parallel on several passwords belonging to separate users.

The registration application and the session application can be produced in the form of separate software packages or in the form of separate features of the same software package. It is particularly advantageous to program the session application and the registration application using the Sun Microsystems® Java® programming system, because it produces software, in a binary and compiled form, which can function regardless of the architecture of the interface device running it. The result is therefore portable session and registration applications, particularly well suited to distribution by download. Furthermore, this programming system is available for all the major architectures and very often already installed in browser programs. It contains the semantic checkers needed to enable an interface device that runs it to check that no prohibited operation has been carried out, so that the execution of the applications obtained in this way is safe.

According to this embodiment, the session application and the registration application can be run by any interface device having a generic and standard access to the network 1, without requiring particular access to the resources of the interface device, apart from what the Java® programming system provides, such as the graphical user interface and the access to the network 1.

Alternatively, the session application can also be implemented in a specific hardware and/or software form in a particular type of interface device, for example in a cellular telephone model which leaves the factory with the session application preinstalled.

There now follows a description of a number of examples of the step 46 with reference to FIGS. 4 to 6. In these figures, the link 54 represents both the connection from the interface device 50 to the network 1 and the network 1 itself or a part of the network 1. Only one content server 2a, 2b or 2c is represented each time because the key server 3 is no longer involved. However, it is still assumed that there can be several content servers and that the interface device 50 is capable of communicating with the key server 3 in order to be able to carry out the steps 30 to 44, which will not be described again.

With reference to FIG. 4, the content server 2a offers the user a personal data bank service. For example, such a data bank can be created with software known by the trade names Apache® or Tomcat®.

A user account 52 is reserved in the storage means of the content server 2a, for example on a hard disk or an optical disk. This account contains personal files of the user 56, which are organized in a hierarchical structure. Each file has been deposited by the user in encrypted form using the symmetric key KS, and this encryption comprises a means of checking the integrity of the files deriving from this same key. The content server 2a treats these files as meaningless strings of bytes, except in respect of the associated metadata (file names and organization). The content server 2a provides an access interface in the form of a website which can be executed from the interface device 50, which in this case takes the form of a generic microcomputer equipped with a conventional browser program, like those offered by Netscape® and Microsoft®.

In the step 46, in this example, the session application places the personal cryptographic data A, KR, KS in a format and in a suitable memory location for the browser program to be able to read it and use it. Using the browser program, the user displays on screen the interface for accessing the content server 2a. A communication in HTTP standard format is then set up between the interface device 50 and the content server 2a, using the certificate A and the corresponding private key KR of the user to secure this communication by an SSL protocol, as was described in the step 22. Preferably, the SSL protocol is used in bi-authenticated manner, as described in the step 22. Thus, the interface device 50 and the content server 2a are mutually authenticated, their subsequent exchanges are confidential, and the integrity of the data transferred can be checked.

The interface for accessing the content server 2a enables the user to ascertain the content and the structure of his account 52, read a file of the account 52, write a file into the account 52 and move or delete a file. For this, the interface device 50 sends appropriate requests 58, according to the known technique. These requests are dealt with by the content server 2a only after the user has been authenticated using the certificate A, so that the files 56 cannot be read or altered by a third party. A third party cannot even know of the existence of these files or the associated metadata, such as the names of the files.

To store a file in the account 52, the user enters this file in the interface device 50, for example by creating the file from a word processing program, or by reading the file from a magnetic, optical or other medium. The browser program then symmetrically encrypts the file using the key KS, and sends the duly encrypted file in the write request 58. The file is stored in the desired location by the content server 2a. The content server 2a does not have the key KS, so the content of the stored files 56 is totally secret from the content server 2a.

To read a file in the account 52, the user specifies that file by its name. The browser program sends a read request 58 including this name to the content server 2a. The content server 2a sends to the interface device 50 a response 60 containing the corresponding file encrypted by the key KS. The browser program then symmetrically decrypts the file using the key KS. Because of the encryption by the key KS, the super-encryption provided by the SSL protocol using a temporary key KT is not essential to ensure the confidentiality of the files 56. However, this super-encryption guarantees the authenticity of the server and of the user throughout the exchanges, which prevents a fake server from deceiving the user as to the content of his account or a fake user from altering the content of the account 52.

The user can store all kinds of personal data in the account 52, in graphical, audio, video, text and other formats. For example, the account 52 contains the electronic address book of the user and his archived electronic mail folders. The account 52 can also contain other cryptographic keys of the user. All this data is kept confidential by its encryption and remains accessible from any interface device equipped with a session application and an appropriate access application, in other words, for example, a browser program. Furthermore, the server 2a can very safely ensure the durability of the files 56, by making backup copies which, because of the strong encryption of the files 56, does not involve any intrinsic risk.

The session application and the registration application can be produced in the form of one or more extension software modules, also called plug-ins, for a browser program, for example for the Netscape Communicator® software. In this case, the session application or the registration application can be launched by an instruction from the interface of the browser program and will be closed automatically when the browser program is shut down.

Alternately, the session application and the registration application can be incorporated in a dedicated program handling the functions for accessing the server 2a.

With reference to FIG. 5, another example of the step 46 is described, in which the service offered is a secured electronic mail service. The server 2b is an electronic mail server able to communicate with the interface device 50 in a manner known per se, for example according to the SMTP (Simple Mail Transfer Protocol), IMAP (Internet Message Access Protocol) or POP (Post Office Protocol). In the step 46, in this example, the session application places the personal cryptographic data A, KR, KS in a format and in an appropriate memory location for a secured electronic mail management client program to be able to read it and use it.

There are electronic mail management client programs which are secured, in other words which comprise a cryptographic module for providing protection functions, and for which the storage of the cryptographic elements is programmable using plug-in software modules. Known examples are Outlook Express® from Microsoft® and Netscape Communicator® from Netscape®, in which the encryption and electronic signature operations are performed according to the S/MIME format.

The session application and/or the registration application can take the form of a plug-in module for such a program. The session application can thus be used to rapidly reconfigure the cryptographic module of the client program with the personal cryptographic data of the user. The benefit of the plug-in software modules for these widely distributed programs is to add to them the characteristics of the registration application and/or of the session application without requiring users to learn how to operate a new program.

The secured electronic mail management client program handles a number of functions. A function for sending encrypted mail comprises the operations involved in receiving a message entered by the user on the interface device 50, specifying a recipient of the message, selecting the public key of that recipient to encrypt the message and/or sign the message with the private key KR and sending the encrypted and/or signed message to the server 2b, as indicated by the arrow 66. The message will then be transmitted via the network 1 to the electronic mail server 62 of the recipient and the recipient will be able to read the message on his own microcomputer 64 equipped with an appropriate client program. A function for receiving encrypted electronic mail comprises the operations consisting in receiving an encrypted message from the server 2b, as indicated by the arrow 68, decrypting the message with the private key KR and/or verifying the signature of the message with the public key of the sender, and presenting the content of the message to the user.

With reference to FIG. 6, another example of the step 46 is described, in which the service offered is a digital television broadcasting service. The server 2c is a digital television server of a supplier to which the user is a subscriber. The user uses an interface device 50 which takes the form of a television set-top box 70 equipped with a remote control 72.

In the step 46, the session application is run by the set-top box 70 to perform a mutual authentication between the user and the server 2c using the certificate A, as was explained with reference to the step 22. Then the user selects a televised program using the remote control 72. The set-top box 70 transmits a corresponding read request 74 to the server 2c. After having verified that the televised program requested is authorized by the subscription of the user, the server 2c sends to the set-top box 70 a corresponding audio-video data stream 76, symmetrically encrypted so it can be decrypted by the set-top box 70 using the key KS or a temporary key KT. For example, the key KS may have been assigned confidentially to the user by the provider in the subscription formalities or have been transmitted by the set-top box 70 to the server 2c after the mutual authentication.

Although the invention has been described in relation to a number of particular embodiments, obviously it is by no means limited to them and comprises all the equivalent techniques of the means described as well as the combinations of them if the latter fall within the context of the invention. In particular, a person skilled in the art will recognize that the order of execution of the steps in the embodiments described can be modified according to numerous variants essentially culminating in the same result and not departing from the context of the invention.

1. A method for the on-line exchange of content data in a secure manner, comprising the steps consisting in:
receiving (32) a code entered by a user in an interface device (4a-c, 50) linked to a first server device (3) by at least one data network (1, 54),
sending (36) a read request from said interface device to said first server device in which is stored the respective personal cryptographic data of a plurality of users, said personal cryptographic data of each user being encrypted using a respective authentic code of said user,
receiving (42) the encrypted personal cryptographic data of said user in said interface device,
decrypting (44) said personal cryptographic data using said entered code when said entered code corresponds to said authentic code of the user,
characterized in that it comprises the steps consisting in:
using (46) said personal cryptographic data to protect an exchange of content data (58, 60, 66, 68, 76) between said interface device and at least one second server device (2a-c) linked to said interface device by at least one data network,
erasing (48) said entered code and said personal cryptographic data from said interface device.

2. The method as claimed in claim 1, characterized in that said interface device and said first server device set up a confidential communication channel between themselves by sharing at least one encryption key (Ks) offering a high degree of entropy in relation to said authentic code of the user, said encrypted personal cryptographic data (F_{KP}(D_{A})) being transmitted to said interface device via said confidential communication channel.

3. The method as claimed in claim 2, characterized in that at least one item of personal code verification data (VP) deriving from said authentic code of the user (P) according to a deterministic function (h(N//.)) is stored in said first server device and in that said first server device explicitly or implicitly authenticates the interface device using said personal code verification data item.

4. The method as claimed in claim 3, characterized in that said deterministic function is a collision-resistant, irreversible function.

5. The method as claimed in claim 3, characterized in that said interface device and said first server device simultaneously handle the sharing of said at least one encryption key and the explicit or implicit authentication of said interface device by said first server device using a Password-Based-Key-Exchange (PBKE) protocol.

6. The method as claimed in claim 5, characterized in that said Password-Based-Key-Exchange type protocol includes a single communication in each direction between said interface device and said first server device, said communication from the first server device to the interface device including the transmission of the encrypted personal cryptographic data.

7. The method as claimed in claim 4, characterized in that said interface device chooses a first integer (a) corresponding to a first element (g^{a} mod p) of a predefined group and said first server device chooses a second integer (b) corresponding to a second element (g^{b} mod p) of said group, then said interface device and said first server device send each other said first and second elements, said interface device and said first server device each producing said at least one encryption key (Ks) by combining the integer chosen by itself and the element received by itself, said first element of the group being transmitted to said first server device in an encrypted form using a distinguishing trace (VP) which derives from said code entered by the user in the interface device according to said deterministic function, said first element of the group being decrypted by said first server device using said personal code verification data (VP), said second element of the group being transmitted to said interface device in a form symmetrically encrypted using said personal code verification data, said second element of the group being decrypted by said interface device using said distinguishing trace.

8. The method as claimed in claim 7, characterized in that said first and second elements of the group are encrypted with a symmetric encryption protocol (E) which is chosen such that an attempt to decrypt one of said elements of the group according to said protocol always produces an element of said group, whatever the data used in said attempt.

9. The method as claimed in claim 7, characterized in that said first and second elements of the group are encrypted with a symmetric encryption protocol (E) which is chosen such that said integer cannot be obtained from the corresponding encrypted group element.

10. The method as claimed in claim 7, characterized in that said first element of the group, respectively said second element of the group, is encrypted with a symmetric encryption protocol (E) which comprises the step consisting in composing said element by a composition law of said group with the image of said distinguishing trace, respectively the image of said personal code verification data, by a function with values in said group.

11. The method as claimed in claim 1, characterized in that said usage step comprises the step consisting in:
authenticating said user with said at least one second server device using the authentication data of said user included in said personal cryptographic data.

12. The method as claimed in claim 1, characterized in that said usage step comprises the steps consisting in:
receiving content data entered by said user in said interface device,
encrypting said content data using at least one encryption key included in said personal cryptographic data,
sending said encrypted content data (58, 66) to said at least one second server device (2a-b) to store said encrypted content data in said second server device and/or transmit it to a recipient.

13. The method as claimed in claim 1, characterized in that said usage step comprises the steps consisting in:
sending a second read request specifying content data from said interface device to said at least one second server device (2a),
receiving said encrypted content data (60) from said at least one second server device in said interface device,
decrypting said content data using at least one decryption key included in said personal cryptographic data.

14. The method as claimed in claim 1, characterized in that it comprises the step consisting in:
imposing (38) a predefined minimum delay between the processing of two successive occurrences of said first read request on the first server device, on pain of not recognizing the longest delayed occurrence.

15. The method as claimed in claim 1, characterized in that it comprises a step consisting in:
systematically monitoring (8) communications involving said first server device (3).

16. The method as claimed in claim 1, characterized in that it comprises the step consisting in:
checking the integrity of the personal cryptographic data received from said first server device using integrity control data attached to said personal cryptographic data received from said first server device.

17. The method as claimed in claim 1, characterized in that it comprises a registration step consisting in:
providing (11, 12) the personal cryptographic data in said interface device,
receiving (14) an authentic code entered by said user in said interface device,
encrypting (20) said personal cryptographic data using said authentic code,
sending (24) said encrypted personal cryptographic data from said interface device to said first server device to store said encrypted personal cryptographic data in said first server device,
erasing (28) said personal cryptographic data and said authentic code from said interface device.

18. The method as claimed in claim 17, characterized in that the registration step comprises the steps consisting in:
forming (18) personal code verification data from said authentic code,
sending (24) said personal code verification data from said interface device to said first server device to store said personal code verification data in said first server device.

19. The method as claimed in claim 17, characterized in that it comprises a step consisting in:
rejecting (14) said authentic code entered by the user when said code satisfies predefined evidence criteria.

20. An interface device (4a-c, 50) for the on-line exchange of content data in a secure manner, comprising:
a means for receiving (32) a code entered by a user,
a means for sending (36) a first read request from said interface device to a first server device (3) in which respective personal cryptographic data of a plurality of users is stored, said personal cryptographic data of each user being encrypted using a respective authentic code of said user,
a means for receiving (42) the encrypted personal cryptographic data of said user,
a means for decrypting (44) said personal cryptographic data using said entered code when said entered code corresponds to said authentic code of the user, characterized by:
means for using (46) said personal cryptographic data to protect an exchange of content data (58, 60, 66, 68, 76) between said interface device and at least one second server device (2a-c),
a means for erasing (48) said code and said personal cryptographic data from said interface device.

21. The device as claimed in claim 20, characterized in that it consists of an electronic mail management program, said means of using the personal cryptographic data comprising a cryptographic module for signing, encrypting and/or decrypting electronic mail using at least some of said personal cryptographic data.

22. The device as claimed in claim 20, characterized in that it consists of a plug-in module suited to an electronic mail management program comprising a cryptographic module for signing, encrypting and decrypting electronic mail, said means of using the personal cryptographic data comprising a means for providing said cryptographic module with at least some of said personal cryptographic data.

23. A registration interface device (4a-c, 50), characterized in that it comprises:
a means for providing (11, 12) personal cryptographic data in said interface device,
a means (6) for receiving (14) an authentic code entered by said user in said interface device,
a means for encrypting (20) said personal cryptographic data using said authentic code,
a means for sending (24) said encrypted personal cryptographic data from said interface device to a first server device (3) to store said encrypted personal cryptographic data in said first server device, in which the respective personal cryptographic data of a plurality of users is stored, said personal cryptographic data of each user being encrypted using a respective authentic code of said user,
a means for erasing (28) said personal cryptographic data and said authentic code from said interface device.
